(19) United States
(12) Patent Application Publication
(10) Pub. No.: US 2016/0290091 A1
(43) Pub. Date: Oct. 6, 2016

(54) DEGRADABLE SEAL MEMBER FOR DOWNHOLE TOOLS, DOWNHOLE TOOL, AND METHOD OF WELL DRILLING AND COMPLETION

(71) Applicant: KUREHA CORPORATION, Chuo-ku, Tokyo (JP)

(72) Inventors: TAKEO TAKAHASHI, Tokyo (JP); MASAYUKI OKURA, Tokyo (JP); TAKUMA KOBAYASHI, Tokyo (JP)

(21) Appl. No.: 15/037,352

(22) PCT Filed: Dec. 25, 2014
(86) PCT No.: PCT/JP2014/084231

§ 371 Date: May 18, 2016

(30) Foreign Application Priority Data
Dec. 27, 2013 (JP) 2013-271311
Nov. 17, 2014 (JP) 2014-232444

(51) Int. Cl. E21B 33/12; C08L 67/04

(52) U.S. Cl. CPC E21B 33/12; C08L 67/04; E21B 43/26

(57) ABSTRACT

Provided is a degradable seal member for downhole tools, the member being formed from a degradable polymer material that is preferred to be a thermoplastic polymer material or a polymer material including an ester bond, an amide bond, or a urethane bond, and that is further preferred to be a polymer material that contains an aliphatic polyester. It is preferred that the degradable seal member exhibits a bending elastic modulus of 0.01 to 8 GPa at 23° C., further preferred that a stable state is maintained in a dry environment and that degradation in a fluid of a temperature not less than 66° C. is possible, and also preferred that a molded article has an annular shape. Also provided are a downhole tool such as a plug for well drilling and completion, and a method of well drilling and completion.

### TECHNICAL FIELD

The present invention relates to a degradable seal member for downhole tools such as a plug for well drilling and completion used in well drilling and completion for producing hydrocarbon resources such as petroleum or natural gas; a downhole tool; and a method of well drilling and completion.

### BACKGROUND ART

Hydrocarbon resources such as petroleum or natural gas have come to be produced by excavation through wells (oil wells or gas wells, also collectively called “wells”) having a porous and permeable subterranean formation. As energy consumption increases, deeper wells are being drilled, reaching depths greater than 9000 m worldwide and greater than 6000 m in Japan. In wells that are continuously excavated, the productive layer is stimulated in order to continuously excavate hydrocarbon resources efficiently from subterranean formations of which permeability has decreased over time and subterranean formations of which permeability is insufficient from the beginning. Known stimulation methods include acid treatment and fracturing. Acid treatment is a method in which the permeability of the productive layer is increased by injecting a mixture of strong acids such as hydrochloric acid and hydrogen fluoride into the productive layer and dissolving the reaction components of bedrock (carbonates, clay minerals, silicates, and the like). However, various problems that accompany the use of strong acids have been identified, and increased costs, including various countermeasures, have also been pointed out. Thus, methods for forming cracks (fractures) in the productive layer using fluid pressure (also called “fracturing” or “hydraulic fracturing”) have received attention.

Hydraulic fracturing is a method in which fractures are generated in the productive layer by fluid pressure such as water pressure (sometimes simply called “hydraulic pressure” hereinafter). Generally, a vertical hole is drilled, and then the vertical hole is curved and a horizontal hole is drilled in a subterranean formation several thousand meters underground. Fracturing fluid is then fed at high pressure into these boreholes (meaning holes provided for forming a well, also called “downholes”), and fractures are produced by the hydraulic pressure in the deep subterranean productive layer (layer that produces the hydrocarbon resource such as petroleum or natural gas), and the productive layer is thereby stimulated in order to extract and recover the hydrocarbon resource through the fractures. The efficacy of hydraulic fracturing has also been examined for the development of unconventional resources such as shale oil (oil that matures in shale) and shale gas.

The following method is typically used to produce fractures by hydraulic pressure and to perform perforation in the productive layer of a deep subterranean formation (layer that produces a hydrocarbon resource, such as petroleum such as shale oil or natural gas such as shale gas) using a high-pressure fluid such as fracturing fluid. Specifically, a prescribed section of a borehole (downhole) drilled and completed in a subterranean formation several thousand meters deep is partially plugged while isolating sequentially from the tip portion of the borehole, and fluid is fed in at high pressure into the plugged section to produce fractures in and to perforate the productive layer. Then, the next prescribed section (typically ahead of the preceding section, i.e., a section closer to the ground surface) is plugged and fracturing and the like are performed. After that, this process is repeated until the required isolation and fracturing have been completed.

The productive layer is sometimes also stimulated again by fracturing of desired sections of boreholes that have already been formed, and not only for drilling of new wells. In this case as well, the operations of borehole plugging, fracturing, and the like are similarly repeated. Additionally, there are also cases where, to perform finishing of the well, the borehole is plugged to block fluid from below, and after finishing of the top portions thereof is performed, the plug is released.

A downhole tool is a tool used in wells for performing plugging, fracturing, and the like of boreholes. A variety of downhole tools are known. For example, Patent Documents 1 to 3 disclose plugs (also sometimes called “frac plugs,” “bridge plugs,” “packers” and the like) which plug or fix boreholes by various members (various elements) being disposed around a core metal.

Patent Document 1 discloses an expansible and degradable plug in which a metal slip or an elastomer seal or the like is disposed on the outer circumferential surface of a mandrel. Patent Document 2 discloses a degradable downhole plug comprising a slip, a conical member, a malleable element formed from an elastomer, rubber, or the like disposed on the outer circumferential surface of a mandrel, and an impediment such as a ball or flapper. Patent Document 3 discloses a biodegradable downhole tool (frac plug) in which a packer element assembly formed of a slip or a plurality of sealing elements is disposed on the outer circumferential surface of a long tubular body member.

Furthermore, Patent Document 4 discloses a sleeve system (also sometimes called a “frac sleeve”) in which fracture sleeve pistons (also sometimes called “pistons” or “piston plugs”) provided so as to pass through a passageway in the center part are sequentially arranged such that they can move in the axial direction of the sleeve, and form sequentially closing spaces by means of ball sealers (also sometimes simply called “balls”) and ball valve seats (also sometimes called “ball seats” or simply “seats”).

Downhole tools used for well drilling and completion are disposed sequentially in a well and perform fracturing, perforation, and the like using high-pressure fluid until the well is completed. Therefore, they require sealing performance such that they can plug (seal) the required sections inside the borehole to withstand hydraulic pressure. At the same time, the used downhole tool must be removed at the stage when production of petroleum such as shale oil or natural gas such as shale gas (hereinafter collectively called “petroleum and natural gas” or “petroleum or natural gas”) is begun. Because the downhole tool such as a plug is typically not designed to be retrievable after use and the release of plugging, it is removed by destruction or by making it into small fragments by milling, drill out, or another method, but substantial cost and time are required for milling, drill out, and the like. There are also plugs specially designed to be retrievable after use (retrievable plugs), but since plugs are placed deep underground, substantial cost and time are required to retrieve all of them.

Patent Document 1 discloses that a slip or mandrel is formed from a degradable metal element such as a reactive metal. Patent Document 2 discloses that flappers, balls, or the like that degrade at a predetermined temperature, pressure, pH, or the like are provided. Patent Document 3 discloses that a plug or member thereof is formed from a biodegradable material, but does not disclose specific usage. Furthermore, Patent Document 4 does not disclose that a frac sleeve is degradable.

Due to increased demand for securement of energy resources and environmental protection, particularly as excavation of unconventional resources expands, excavation conditions are becoming increasingly harsh, such as increased depth. Furthermore, diversification of excavation conditions is advancing, such as the diversification of temperature conditions from approximately 60° C. to approximately 200° C. attendant to diversification of depth. Specifically, various properties are required for the downhole seal component used in downhole tools such as frac plugs, bridge plugs, packers, cement retainers, and sleeve systems (frac sleeves). These properties include mechanical strength (tensile strength and compressive strength) to allow the member to be transported to a depth of several thousand meters underground; oil-resistance, water-resistance, and heat-resistance such that mechanical strength and the like are maintained when it comes in contact with the hydrocarbon to be recovered in the high-temperature and high-humidity environment of a deep underground downhole; seal performance such that plugging can be maintained against high hydraulic pressure caused by sealing a fluid between the downhole tool and the inner wall of the borehole, specifically the casing disposed on the interior of the borehole, when plugging a prescribed space of a downhole for perforation and fracturing; and the like. Additionally, the characteristics of being easily removable and of improving production efficiency by completely releasing the fluid seal under the environmental conditions of that well (as described previously, there are diverse environments with regard to temperature conditions and other conditions accompanying diversification of depth) at the stage when a well for hydrocarbon resource recovery has been completed have also come to be required.

Thus, there has been a demand for a member for downhole tools that makes it easy to reliably perform various well treatments in well drilling and completion that require sealing operations such as perforation and fracturing by sealing a fluid between the downhole tool and the casing, and, as necessary, makes it easy to release the seal, remove the seal, and secure a flow path under a diversity of well environment conditions based on the fact that excavation conditions have become more harsh and diverse such as increased depth, and that contributes to reduced expense or shortening of processes, and contributes to improved production efficiency.

### CITATION LIST

### Patent Literature

Patent Document 1: US Patent Application Publication No. 2011/0067889 A1 specification

Patent Document 2: US Patent Application Publication No. 2011/0277989 A1 specification

Patent Document 3: US Patent Application Publication No. 2005/0205266 A1 specification

Patent Document 4: US Patent Application Publication No. 2010/0132959 A1 specification

### SUMMARY OF INVENTION

### Technical Problem

A first aspect of the problem of the present invention is, to provide a member for downhole tools that makes it easy to reliably perform various well treatments in well drilling and completion that require sealing operations such as perforation and fracturing by sealing a fluid between the downhole tool and the casing, and, as necessary, can easily release the seal, remove the seal, and secure a flow path under a diversity of well environment conditions based on the fact that excavation conditions have become more harsh and diverse such as increased depth, and that contributes to reduced expense or shortening of well drilling and completion, and contributes to improved production efficiency. Another aspect of the problem of the present invention is to provide a downhole tool comprising that member. Yet another aspect of the problem of the present invention is to provide a method of well drilling and completion using the member for downhole tools.

### Solution to Problem

As a result of diligent research to solve the above problems, the present inventors discovered that the problems can be solved by forming a seal member for downhole tools, which is a member for downhole tools, from a degradable polymer material, and thereby achieved the present invention.

That is, the present invention provides (1) a degradable seal member comprises a degradable polymer material.

As specific modes according to the first aspect of the present invention, the degradable seal members for downhole tools of (2) to (16) below are provided.

(2) The degradable seal member for downhole tools according to the above (1), wherein a bending elastic modulus at 23° C. is from 0.01 to 8 GPa.

(3) The degradable seal member for downhole tools according to the above (2), wherein a bending elastic modulus at 23° C. is from 0.05 to 6 GPa.

(4) The degradable seal member for downhole tools according to any one of the above (1) to (3), wherein the member maintains a stable state in a dry environment and is degradable in fluid of a temperature of not less than 66° C.

(5) The degradable seal member for downhole tools according to any one of the above (1) to (4), wherein a decrease rate of a 50% strain compressive stress of the degradable polymer material after immersion for 24 hours in 150° C. water relative to a 50% strain compressive stress before immersion is not less than 5%.

(6) The degradable seal member for downhole tools according to any one of the above (1) to (5), wherein a loss rate of mass of the degradable polymer material after immersion for 72 hours in 150° C. water relative to a mass before immersion is from 5 to 100%.

(7) The degradable seal member for downhole tools according to any one of the above (1) to (6), wherein the degradable polymer material contains a thermoplastic polymer material.

(8) The degradable seal member for downhole tools according to any one of the above (1) to (7), wherein the degradable polymer material contains not less than two types of degradable polymer material.

(9) The degradable seal member for downhole tools according to any one of the above (1) to (8), wherein the degradable polymer material contains a polymer material containing at least one ester bond, amide bond, or urethane bond.

(10) The degradable seal member for downhole tools according to any one of the above (1) to (9), wherein the degradable polymer material contains an aliphatic polyester.

(11) The degradable seal member for downhole tools according to the above (10), wherein the aliphatic polyester is a copolymer.

(12) The degradable seal member for downhole tools according to the above (10) or (11), wherein the aliphatic polyester contains at least one type selected from the group consisting of polylactic acid, stereocomplex-type polylactic acid, polybutylene succinate, polybutylene adipate/terephthalate, and polybutylene succinate/adipate.

(13) The degradable seal member for downhole tools according to any one of the above (1) to (12), wherein the degradable polymer material contains an acidic substance (which may also be an acid-producing substance).

(14) The degradable seal member for downhole tools according to any one of the above (1) to (13), wherein the degradable polymer material contains a reinforcing material.

(15) The degradable seal member for downhole tools according to any one of the above (1) to (14), wherein a tensile fracture strain is not less than 20%.

(16) The degradable seal member for downhole tools according to any one of the above (1) to (15), wherein the member is an annular molded article disposed on an outer circumferential surface orthogonal to an axial direction of a mandrel provided in a downhole tool.

Furthermore, another aspect of the present invention provides (17) a downhole tool comprising the degradable seal member for downhole tools described in any one of the above (1) to (16).

Further aspects of the present invention provide the methods for well drilling and completion of the below (18) and (19).

(18) A method for well drilling and completion, the method comprising sealing a fluid between a downhole tool and a casing using the degradable seal member for downhole tools described in any one of the above (1) to (16).

(19) A method for well drilling and completion, the method comprising performing isolation treatment of a borehole using the degradable seal member for downhole tools described in any one of the above (1) to (16), and then the downhole tools being degraded.

Yet further aspects of the present invention provide the methods of well drilling and completion of the below (20) to (23).

(20) A method for well drilling and completion, the method comprising sealing a borehole using a downhole tool comprising a degradable seal member for downhole tools formed from a degradable polymer material and having a bending elastic modulus at 23° C. of 0.01 to 8 GPa, and maintaining a stable state in a dry environment and being degradable in fluid of a temperature of not less than 66° C.; and then the degradable seal member for downhole tools being degraded inside the borehole.

(21) A method for well drilling and completion, the method comprising sealing a borehole using a downhole tool comprising a degradable seal member for downhole tools formed from a degradable polymer material and having a bending elastic modulus at 23° C. of 0.01 to 8 GPa, and maintaining a stable state in a dry environment and being degradable in fluid of a temperature of not less than 66° C.,

the downhole tool further comprising another member for downhole tools containing a degradable material; and then the degradable seal member for downhole tools being degraded inside the borehole.

(22) The method for well drilling and completion according to the above (21), wherein the degradable material contained in the other member for downhole tools is polyglycolic acid.

(23) A method for well drilling and completion, the method comprising performing well treatment using a downhole tool comprising a degradable seal member for downhole tools formed from a degradable polymer material and having a bending elastic modulus at 23° C. of 0.01 to 8 GPa, and maintaining a stable state in a dry environment and being degradable in fluid of a temperature of not less than 66° C., the degradable seal member for downhole tools being in contact with another member for downhole tools; and then the degradable seal member for downhole tools being degraded inside the borehole.

### Advantageous Effects of Invention

According to the present invention, provided is a member for downhole tools which, due to being a degradable seal member for downhole tools characterized by being formed from a degradable polymer material, and due to preferably having a bending elastic modulus of 0.01 to 8 GPa at 23° C., or maintaining a stable state in a dry environment and being degradable in fluid of a temperature not less than 66° C., and due to preferably having a decrease rate of 50% strain compressive stress of the polymer material after immersion for 24 hours in 150° C. water relative to the 50% strain compressive stress before immersion of not less than 5%, or having a loss rate of mass of the polymer material after immersion for 72 hours in 150° C. water relative to the mass before immersion of 5 to 100%, makes it easy to reliably perform various well treatments in well drilling and completion that require sealing operations such as perforation and fracturing by sealing a fluid between the downhole tool and the casing, and, as necessary, can easily release the seal, remove the seal, and secure a flow path under a diversity of well environment conditions based on the fact that excavation conditions have become more harsh and diverse such as increased depth, and that contributes to reduced expense or shortening of processes well drilling and completion, and contributes to improved production efficiency. Also provided are a downhole tool comprising the member, and a method of well drilling and completion.

### DESCRIPTION OF EMBODIMENTS

### I. Degradable Seal Member for Downhole Tools

The degradable seal member for downhole tools that is the first aspect of the present invention is characterized by being formed from a degradable polymer material.

### 1. Degradable Polymer Material

### [Degradability]

In the degradable polymer material that forms the degradable seal member for downhole tools of the present invention, degradability may indicate, for example, biodegradability, meaning that it is degraded by microorganisms in the soil in which the fracturing fluid is used, or hydrolyzability, meaning that it is degraded by water, and also by acids or alkalis if desired, or degradability, meaning that it can be degraded chemically by some other method. Preferably, it indicates hydrolyzability, meaning that it degraded by water of not less than a prescribed temperature. Note that the property of physically losing shape, such as destruction or disintegration by the application of large mechanical force, as in metal materials such as aluminum widely used for mandrels provided in conventional plugs for well drilling and completion, do not qualify as the aforementioned degradability. However, the property of polymer materials becoming weak due to the intrinsic strength of resin materials decreasing due to a reduction in the degree of polymerization or the like, resulting in them disintegrating and losing their initial shape (sometimes called “disintegrability” hereinafter) when a very small mechanical force is applied, also qualifies as degradability.

### [Polymer Material]

The degradable polymer material that forms the degradable seal member for downhole tools of the present invention is not particularly limited as long as it enables obtaining a degradable seal member for downhole tools that, based on the fact that excavation conditions have become more harsh and diverse such as increased depth, makes it easy to perform operations such as perforation and fracturing by reliably sealing a fluid between the downhole tool and the casing, and, as necessary, makes it easy to remove the seal and secure a flow path, thereby reducing the expenses and shortening the processes of well drilling and completion. From the perspective of it being easy to prepare a degradable seal member for downhole tools of a desired shape and size, a degradable seal member for downhole tools in which the degradable polymer material contains a thermoplastic polymer material is preferred. Furthermore, the degradable seal member for downhole tools in which the degradable polymer material contains not less than two types of degradable polymer material may be preferably used because degradability and sealing ability of the degradable seal member for downhole tools in the downhole environment can be easily adjusted. Additionally, the degradable seal member for downhole tools in which the degradable polymer material contains at least one ester bond, amide bond, or urethane bond in the main chain of the polymer is preferred because it readily has preferred characteristics as a degradable seal member for downhole tools, such as the previously described bending elastic modulus at 23° C., and, as desired, tensile fracture strain, and because hydrolyzability, meaning that it is degraded by water of not less than a prescribed temperature, is desired as the type of degradability. Therefore, the degradable polymer material that forms the degradable seal member for downhole tools of the present invention preferably contains a polymer material formed from a polyester-, polyamide-, or polyurethane-based polymer (homopolymer or copolymer), and from the perspective of easily having the characteristics suitable for a degradable seal member for downhole tools, the degradable polymer material more preferably contains an aliphatic polyester. Furthermore, an elastic body (rubber, elastomer) capable of shape restoration, which has been used widely for conventional seal members, may be used as the degradable polymer material that forms the degradable seal member for downhole tools of the present invention. However, since the shape of the seal member is not necessarily restored when production of hydrocarbon resources begins after withstanding a high load applied to the seal member in order to perform fracturing or the like, the degradable polymer material that forms the degradable seal member for downhole tools is not necessarily an elastic body.

### [150° C. 24-Hour Compressive Stress Decrease Rate]

From the perspective of reliably exhibiting degradability in a downhole environment, the degradable polymer material that forms the degradable seal member for downhole tools of the present invention preferably has a decrease rate of 50% strain compressive stress after immersion for 24 hours in 150° C. water relative to 50% strain compressive stress before immersion (sometimes called “150° C. 24-hour compressive stress decrease rate” hereinafter) of not less than 5%. The method for measuring the 150° C. 24-hour compressive stress decrease rate of the degradable polymer material that forms the degradable seal member for downhole tools is as follows. Specifically, a sample having a prescribed shape prepared from a degradable polymer material (for example, a sample prepared by cutting out a piece with a thickness, length, and width of 5 mm each from a seal member formed from the degradable polymer material may be used) is immersed in 400 mL of 150° C. water (deionized water or the like) and then removed after 24 hours, and compressive stress is measured at room temperature according to JIS K7181 (conforming to ISO 604), and 50% strain compressive stress (compressive stress at 50% compressive strain; similarly hereinafter; units: MPa) is determined. By comparing with the 50% strain compressive stress measured in advance before immersion in 150° C. water (“initial compressive stress”), the decrease rate (units: %) relative to the initial compressive stress is calculated. When the degradable polymer material that forms the degradable seal member for downhole tools loses its shape or disappears as a result of degradation or elution while immersed in 150° C. water, or, when the degradable seal member for downhole tools disintegrates before reaching 50% strain when compressive stress is measured, the decrease rate is taken to be 100%.

The initial compressive stress of the degradable polymer material that forms the degradable seal member for downhole tools, i.e., the 50% strain compressive stress before immersion in 150° C. water, is not particularly limited as long as the strength of the degradable seal member for downhole tools is maintained and it can reliably continue to plug the downhole for the duration required to perform well treatment such as fracturing in a deep underground downhole (the required duration including transport or moving the plug to the prescribed location, plugging the downhole with the degradable seal member for downhole tools, and preparation for and implementation of perforation or fracturing; generally about 1 to 2 days). However, it is normally not less than 5 MPa, and often not less than 7 MPa, and particularly preferably not less than 10 MPa. There is no particular upper limit on the initial 50% strain compressive stress of the degradable polymer material that forms the degradable seal member for downhole tools, but from the perspectives of ease of handling and degradability (or disintegrability), it is normally not greater than 200 MPa, and often not greater than 150 MPa.

Due to the fact that the degradable polymer material that forms the degradable seal member for downhole tools has a 150° C. 24-hour compressive stress decrease rate of not less than 5%, the degradable seal member for downhole tools formed from the degradable polymer material degrades or disintegrates within a desired period within several hours to several weeks in a downhole environment (attendant to diversification of depth, there are downhole environments at temperatures from approximately 60° C. to approximately 200° C., and recently at low temperatures from 25 to 40° C.). Thus, because the sealing function by the degradable seal member for downhole tools is lost and it does not require a great deal of expense or time for retrieval or physical destruction or the like, it can contribute to reduced expense or shortening of processes for well drilling and completion. A degradable seal member for downhole tools requires a diversity of functional maintenance time and functional loss time of the sealing function according to various environments such as downhole temperatures and according to the processes carried out in those environments. Due to the fact that the degradable polymer material that forms the degradable seal member for downhole tools of the present invention has a 150° C. 24-hour compressive stress decrease rate of preferably not less than 5%, more preferably not less than 20%, even more preferably not less than 50%, particularly preferably not less than 70%, and most preferably 100%, it can have the characteristic of exhibiting a sealing function for a certain time and then losing the sealing function and releasing the seal in various downhole temperature environments, such as, for example, 177° C., 163° C., 149° C., 121° C., 93° C., 80° C., or 66° C., as well as 25 to 40° C.

The factors that control the 150° C. 24-hour compressive stress decrease rate of the degradable polymer material that forms the degradable seal member for downhole tools and the degree to which they can be controlled differ depending on the type of degradable polymer material, e.g., degradable rubber, but, for example, it is possible to control the degradation speed by the following means: adjusting the degree of vulcanization and degree of crosslinking; changing the vulcanization method; changing the type and ratio of the crosslinking agent; changing the hardness (in general, degradation is suppressed when hardness is increased, and degradation is accelerated when hardness is decreased); adjusting the type and quantity of fillers and blended agents such as hydrolysis inhibitors in the degradable polymer material; and changing molding conditions and curing conditions. The upper limit of the 150° C. 24-hour compressive stress decrease rate of the degradable polymer material is 100%. The degradable polymer material that forms the degradable seal member for downhole tools of the present invention may also be adjusted as necessary so that the 150° C. 24-hour compressive stress decrease rate is 100% and the decrease rate of the 50% strain compressive stress after immersion for 24 hours in water of various temperatures, such as 93° C., 66° C., 40° C. or 25° C., relative to the 50% strain compressive stress before immersion is, for example, not greater than 30%, not greater than 10%, not greater than 8%, or less than 5%.

### [150° C. 72-Hour Mass Loss Rate]

From the perspective of reliably exhibiting degradability in a downhole environment, the degradable polymer material that forms the degradable seal member for downhole tools of the present invention preferably has a loss rate of mass after immersion for 72 hours in 150° C. water relative to mass before immersion (sometimes called “150° C. 72-hour mass loss rate” hereinafter) of 5 to 100%. The 150° C. 72-hour mass loss rate of a degradable polymer material that forms a degradable seal material for downhole tools is calculated by taking a sample of a prescribed shape prepared from a degradable polymer material (for example, a sample prepared by cutting out a piece with a thickness, length, and width of 20 mm each from a seal member formed from the degradable polymer material may be used), and immersing it in 400 mL of 150° C. water, then removing it after 72 hours and measuring its mass, and comparing this mass with the mass of the sample measured in advance before immersion in the 150° C. water (sometimes called “initial mass” hereinafter). Due to the fact that the degradable polymer material that forms the degradable seal member for downhole tools has a 150° C. 72-hour mass loss rate of 5 to 100%, the degradable seal member for downhole tools formed from a polymer material containing a prescribed amount of degradable polymer material degrades or disintegrates and preferably disappears within several hours to several weeks in a downhole environment, and thus, because the sealing function by the degradable seal member for downhole tools is lost, it can contribute to reduced expense or shortening of processes for well drilling and completion. A degradable seal member for downhole tools requires a diversity of functional maintenance time and functional loss time of the sealing function according to various environments such as downhole temperatures and according to the processes carried out in those environments. Due to the fact that the degradable seal member for downhole tools of the present invention has a 150° C. 72-hour mass loss rate of 10 to 100%, more preferably from 50 to 100%, particularly preferably from 80 to 100%, and most preferably from 90 to 100%, it can have the characteristic of exhibiting a sealing function for a certain time and then losing the sealing function and releasing the seal in various downhole temperature environments, such as, for example, 177° C., 163° C., 149° C., 121° C., 93° C., 80° C., or 66° C., as well as 25 to 40° C. The factors that control the 150° C. 72-hour mass loss rate of the degradable polymer material that forms the degradable seal member for downhole tools and the degree to which they can be controlled are the same as those described above for the 150° C. 24-hour compressive stress decrease rate.

A degradable seal member for downhole tools requires a diversity of functional maintenance time and functional loss time of the sealing function according to various environments such as downhole temperatures and according to the processes carried out in those environments. Due to the fact that the degradable polymer material that forms the degradable seal member for downhole tools of the present invention has a 150° C. 24-hour compressive stress decrease rate and/or a 150° C. 72-hour mass loss rate within the prescribed ranges, the degradable seal member for downhole tools of the present invention can have the characteristic of exhibiting a sealing function for a certain time and then losing the sealing function and releasing the seal in various downhole temperature environments. Therefore, an optimal degradable polymer material for the degradable seal member for downhole tools of the present invention can be selected according to the downhole environment and processes from degradable polymer materials having the prescribed 150° C. 24-hour compressive stress decrease rate and/or a 150° C. 72-hour mass loss rate.

### [Aliphatic Polyester]

The aliphatic polyester that is the more preferred polymer for the degradable polymer material that forms the degradable seal member for downhole tools of the present invention is an aliphatic polyester obtained by, for example, homopolymerization or copolymerization of an oxycarboxylic acid and/or a lactone, an esterification reaction of an aliphatic dicarboxylic acid and an aliphatic diol, or copolymerization of an aliphatic dicarboxylic acid, an aliphatic diol, and an oxycarboxylic acid and/or a lactone. It preferably dissolves quickly in water of a temperature from approximately 20 to 100° C.

Examples of oxycarboxylic acids include aliphatic hydroxycarboxylic acids having from 2 to 8 carbons, such as glycolic acid, lactic acid, malic acid, hydroxypropionic acid, hydroxybutyric acid, hydroxypentanoic acid, hydroxycaproic acid, hydroxyheptanoic acid, and hydroxyoctanoic acid, and the like. Examples of lactones include lactones having from 3 to 10 carbons, such as propiolactone, butyrolactone, valolactone, and ε-caprolactone, and the like.

Examples of aliphatic dicarboxylic acids include aliphatic saturated dicarboxylic acids having from 2 to 8 carbons, such as oxalic acid, malonic acid, succinic acid, glutaric acid, and adipic acid, and aliphatic unsaturated dicarboxylic acids having from 4 to 8 carbons, such as maleic acid and fumaric acid, and the like. Examples of aliphatic diols include alkylene glycols having from 2 to 6 carbons, such as ethylene glycol, propylene glycol, butanediol, and hexanediol, and polyalkylene glycols having from 2 to 4 carbons, such as polyethylene glycol, polypropylene glycol, and polybutylene glycol.

The components that form the aliphatic polyester may be each used alone or in combinations of two or more types. Furthermore, components that form an aromatic polyester such as terephthalic acid may be used in combination provided that the properties as a degradable resin are not lost.

Specific examples of aliphatic polyesters include polylactic acid (PLA), polybutylene succinate (PBS), polybutylene adipate/terephthalate (PBAT), polybutylene succinate/adipate (PBSA), polyethylene succinate (PES), polyglycolic acid (PGA), glycolic acid/lactic acid copolymer (PGLA), polycaprolactone (PCL), and the like. A copolymer, specifically PBSA, PBAT, PGLA, or the like, is more preferred as the aliphatic polyester because characteristics suitable for a degradable seal member for downhole tools are relatively easy to adjust and because molding processability is excellent.

As previously described, the degradable seal member for downhole tools in which the degradable polymer material contains not less than two types of degradable polymer material may be preferably used. For example, as types of PLA, poly-L-lactic acid (PLLA) and poly-D-lactic acid (PDLA) are known, but when a mixture of PLLA and PDLA is mixed, their respective molecular chains advantageously intertwine to form a stereocomplex (also sometimes called “stereocomplex polylactic acid” or “SCPLA”; SCPLA is encompassed in PLA in the broad sense, but is often differentiated from PLA), and since heat resistance increases, SCPLA may be preferably used to form the degradable seal member for downhole tools from the perspective of use at high temperature.

Therefore, more specifically, a degradable seal member for downhole tools in which the aliphatic polyester contains at least one type selected from the group consisting of PLA, SCPLA, PBS, PBAT, and PBSA may be preferably used as the degradable seal member for downhole tools of the present invention.

### [Other Blended Components]

The degradable polymer material, particularly preferably the polymer material containing an aliphatic polyester, and above all the polymer material containing an aliphatic polyester copolymer, may also contain or be blended with, as other blended components, other resin materials or various additives such as stabilizers, degradation accelerators, or degradation inhibitors, and reinforcing materials, within a range that does not hinder the object of the present invention.

### [Degradation Accelerator]

The degradable polymer material may also contain a degradation accelerator. The degradation accelerator contained in the degradable polymer material is a blended agent that can accelerate degradation or disintegration of the degradable polymer material in the downhole environment in which the degradable seal member for downhole tools is used. In particular, it is a blended agent contained in the polymer material that can accelerate degradation of the degradable polymer material, especially hydrolysis. A blended agent having a function of breaking the bonds of the main chain of the polymer molecules of the degradable polymer material or having a function of plasticizing the degradable polymer material is preferred as the degradation accelerator because it is anticipated to have an effect of reliably degrading the degradable polymer material, and therefore, acidic substances are cited as preferred degradation accelerators.

### [Acidic Substance]

Specifically, due to the fact that acidic substances break the bonds of the main chain of polymer molecules contained in the degradable polymer material that forms the degradable seal member for downhole tools, they accelerate degradation of the polymer material, and as a result, accelerate degradation of the degradable seal member for downhole tools. When the degradable seal member for downhole tools is formed from a degradable polymer material containing an acidic substance, the acidic substance normally is present in a uniformly dispersed state, and therefore, the acidic substance contacts the polymer molecules substantially. It is surmised that, as a result, degradation of the degradable seal member proceeds at higher speed than when degradation proceeds from the surface of the seal member, as is the case when, for example, the degradable seal member for downhole tools formed from a degradable polymer material is immersed in water (optionally containing an acidic substance). Therefore, an acidic substance is a preferred degradation accelerator.

The acidic substance may be an acidic substance in the narrow sense such as an acid, or it may be an acid-producing substance that hydrolyzes to produce acid under certain conditions, for example, when immersed in water. Accordingly, in addition to acids such as organic acids and inorganic acids, examples of acid-producing substances include acid-producing substances known themselves as acid precursors, such as derivatives of hydrolyzable acids such as dimers, trimers, oligomers, or polymers of oxycarboxylic acids, derivatives of organic acids with higher reactivity such as the sulfonic acid derivative, sulfonic acid ester (which qualifies as an organic acid ester), sulfonamides, inorganic acid esters, acid anhydrides, and the like. Furthermore, the acidic substance must be something that does not degrade, volatilize, or disappear during the time until the degradable seal member for downhole tools is formed from the degradable polymer material containing a prescribed amount of acidic substance (during polymerization of the degradable polymer material, during melt-kneading or melt-molding, and the like). From the above perspectives, specific examples of acidic substances include saturated fatty acids having from 8 to 20 carbons, such as lauric acid; oxycarboxylic acids, such as glycolic acid, lactic acid, phosphoric acid, glycolide, glycolic acid oligomer, lactide, and lactic acid oligomer, or derivatives thereof; sulfonic acid derivatives, such as methyl p-toluene sulfonate (MPTS), o/p-toluene sulfonamide, and N-butylbenzene sulfonamide; acid anhydrides such as phthalic anhydride and 3,3′,4,4′-benzophenone tetracarboxylic acid dianhydride (BTDA); and the like. Those acidic substances used as degradation accelerators that contain at least one type selected from the group consisting of the acid-producing substances glycolide, lactide, and phthalic anhydride are particularly preferred.

The acidic substance may be in a phase-soluble state in the degradable polymer material that forms the degradable seal member for downhole tools, or may be dispersed in granular form (also called “particulate form”). In either case, it has the effect of accelerating degradation of the degradable polymer material, but the degradation accelerating effect is larger when in a phase-soluble state. The content of the acidic substance used as a degradation accelerator relative to 100 parts by mass of the degradable polymer material is not particularly limited, but it has a degradation accelerating effect on the degradable polymer material when in the range of, normally, from 0.1 to 20 parts by mass, often from 0.3 to 15 parts by mass, and in nearly all cases from 0.5 to 10 parts by mass.

### [Reinforcing Material]

The degradable polymer material may also contain a reinforcing material. As reinforcing materials, materials such as resin materials conventionally used as reinforcing materials with the objective of improving mechanical strength or heat resistance may be used, and fibrous reinforcing materials or granular or powdered reinforcing materials may be used. The reinforcing materials may be contained typically in the amount of not greater than 150 parts by mass, and preferably in the range of 10 to 100 parts by mass, relative to 100 parts by mass of the degradable polymer material. When the degradable polymer material that forms the degradable seal member for downhole tools of the present invention contains a reinforcing material, it may be capable of sealing for the duration required for treatment even when the downhole environment is close to the melting point of the degradable polymer material.

Examples of fibrous reinforcing materials include inorganic fibrous substances such as glass fibers, carbon fibers, asbestos fibers, silica fibers, alumina fibers, zirconia fibers, boron nitride fibers, silicon nitride fibers, boron fibers, and potassium titanate fibers; metal fibrous substances such as stainless steel, aluminum, titanium, steel, and brass; and organic fibrous substances with a high melting point such as aramid fibers, kenaf fibers, polyamides, fluorine resins, polyester resins, and acrylic resins; and the like. Short fibers having a length of not greater than 10 mm, more preferably 1 to 6 mm, and even more preferably 1.5 to 4 mm, are preferable as the fibrous reinforcing materials. Furthermore, inorganic fibrous substances are preferably used, and glass fibers are particularly preferable.

As the granular or powdered reinforcing material, mica, silica, talc, alumina, kaolin, calcium sulfate, calcium carbonate, titanium oxide, ferrite, clay, glass powder (milled fiber or the like), zinc oxide, nickel carbonate, iron oxide, quartz powder, magnesium carbonate, barium sulfate, and the like can be used. These reinforcing materials may be each used alone or in combinations of two or more types. The reinforcing material may be treated with a sizing agent or surface treatment agent as necessary.

### [Control of Degradation Time, Degradation Speed]

The factors that control the degradation time, degradation speed, and the like of the degradable polymer material that forms the degradable seal member for downhole tools of the present invention and the degree to which they can be controlled differ depending on the type of polymer material, but, for example, it is possible to control the degradation speed by adjusting the molecular weight, adjusting the copolymer proportions, adjusting the degree of crystallization, and adjusting the type and amount of blended agent or filler material (reinforcing material and the like) such as a hydrolysis inhibitor and/or a degradation accelerator such as acidic substances, and it is possible to control the degradation speed by varying the molding conditions or aging conditions. Furthermore, in a degradable polymer material which is hydrolyzable or biodegradable, the above factors and degree may be adjustable by a plurality of techniques, such as adjusting the degree of copolymerization and adding a degradation accelerator and/or hydrolysis inhibitor.

### [Degradation Characteristics in Downhole Environment]

By selecting the degradable seal member for downhole tools of the present invention from degradable polymer materials having the compositions and characteristics described above, the sealing function can be lost due to the fact that the degradable seal member for downhole tools can degrade or disintegrate and disappear as well as lose strength within several hours to several weeks in the downhole environment described previously. Therefore, the degradable polymer material that forms the degradable seal member for downhole tools can contribute to reducing the expense or shortening the processes of well drilling and completion for recovering hydrocarbon resources without requiring a substantial cost and time for retrieving or physically destroying the member for downhole tools for the purpose of releasing the plugging of the space between the casing and the downhole tool such as a plug for well drilling and completion or the like.

### 2. Degradable Seal Member for Downhole Tool

### [Bending Elastic Modulus at 23° C.]

The degradable seal member for downhole tools of the present invention preferably has a bending elastic modulus at 23° C. in the range of 0.01 to 8 GPa from the perspective of reliably exhibiting a sealing function in a downhole environment. When the 23° C. bending elastic modulus of the degradable seal member for downhole tools of the present invention is in the range of 0.01 to 8 GPa, when a borehole is plugged in an environment at 177° C., 163° C., 149° C., 121° C., 93° C., 80° C., or 66° C., as well as 25 to 40° C., for example, when fluid is to be sealed between the downhole tool and the casing, the degradable seal member for downhole tools can deform so as to reliably fit to the shape of the downhole tool and the shape of the casing because the bending elastic modulus of the degradable seal member for downhole tools is reduced to an appropriate degree in those downhole environments. Therefore, the contact area between the degradable seal member for downhole tools and the casing is large, and plugging is reliable. Additionally, due to the large contact area described above, it has the effect that the fluid seal is difficult to break even if extremely high pressure is applied by fluid for implementing a treatment that requires sealing such as fracturing. The 23° C. bending elastic modulus is measured in conformance with JIS K7113 (equivalent to ISO 178). Specifically, when the degradable polymer material is crystalline, a test piece (no. 1 test piece) is prepared in a shape stipulated in JIS K7113 by heating the degradable polymer material to not less than its melting point, and then molding it in a mold set to a temperature near the crystallization temperature using an injection molder having a single full flight screw, and then cooling. When the degradable polymer material is amorphous, a test piece of the same shape is prepared by heating it to not less than its glass transition temperature, and then molding it in a mold set to a temperature not greater than the glass transition temperature, and then cooling. In either case, the gate is the end portion relative to the long direction of the test piece. For the prepared test piece, a tensile test is performed at a speed of 50 mm/min at room temperature (23° C.±1° C.), and the tensile stress when the test piece breaks is measured, and the 23° C. bending elastic modulus is calculated (average of n=5; units: GPa).

From the perspective of obtaining something that easily deforms to ensure a sealing function in a downhole environment, the 23° C. bending elastic modulus of the degradable seal member for downhole tools is preferably not greater than 7 GPa, more preferably not greater than 6 GPa, and even more preferably not greater than 5 GPa, and it is particularly effective in a seal member greater than 5 mm thick. When the 23° C. bending elastic modulus of the degradable seal member for downhole tools is too small, it may deform and the seal may break when high hydraulic pressure is applied. Thus it should be not less than 0.015 GPa, more preferably not less than 0.03 GPa, and even more preferably not less than 0.05 GPa. Therefore, it is particularly preferred that the 23° C. bending elastic modulus of the degradable seal member for downhole tools of the present invention be from 0.03 to 7 GPa, and most preferably from 0.05 to 6 GPa.

### [Dry Stability]

The degradable seal member for downhole tools of the present invention is preferred because the shape and sealing performance of the degradable seal member for downhole tools are maintained and it can more reliably plug the downhole for the duration required to perform well treatment such as fracturing, due to the fact that it maintains a stable state in a dry environment and can degrade in fluid of a temperature not less than 66° C. (sometimes called “dry stability” hereinafter). That is, based on the fact that excavation conditions for well drilling and completion have become diverse, the downhole tool that comprises the degradable seal member for downhole tools of the present invention is disposed in a borehole and does not lose its sealing function at the stage before well treatment such as fracturing is performed, and after well treatment is performed, the degradable seal member for downhole tools can be degraded in a desired short time by contact with a fluid of a temperature not less than 66° C. Note that for the degradable seal member for downhole tools of the present invention, “stable in a dry environment” means that compressive stress does not decrease for at least 168 hours (7 days) in an environment at temperature 23° C. and relative humidity 50%. Additionally, “degradable in fluid of a temperature not less than 66° C.” means that the decrease rate of compressive stress after immersion for 168 hours (7 days) in 66° C. water (deionized water or the like) relative to the compressive stress before immersion is not less than 5%, preferably not less than 20%, more preferably not less than 50%, and even more preferably 100%.

### [Tensile Fracture Strain]

The degradable seal member for downhole tools of the present invention preferably has a tensile fracture strain in the downhole environment of not less than 20%, from the perspective of reliably exhibiting a sealing function in the downhole environment. When the tensile fracture strain of the degradable seal member for downhole tools of the present invention is not less than 20%, when a borehole is plugged, e.g., when fluid is to be sealed between the downhole tool and the casing, the degradable seal member for downhole tools can deform so as to reliably fit to the shape of the downhole tool and the shape of the casing, and specifically, even if it deforms while incurring large tensile force or compressive force, there is no risk of fracture. Therefore, the contact area of the degradable seal member for downhole tools and the casing is large, resulting in reliable plugging. Additionally, due to the large contact area described above, it has the effect that the fluid seal is difficult to break even if it incurs large tensile force or compressive force due to extremely high pressure being applied by fluid for implementing a treatment that requires sealing such as fracturing. Tensile fracture strain is measured in conformance with ISO 527 at a prescribed temperature corresponding to the desired downhole environment, such as, for example, 177° C., 163° C., 149° C., 121° C., 93° C., 80° C., or 66° C., as well as 25 to 40° C., using a sample prepared by the method described previously in regard to the method for measuring bending elastic modulus (average of n=5; units: %).

From the perspective of obtaining something that easily deforms to ensure a sealing function in a downhole environment, the tensile fracture strain of the degradable seal member for downhole tools is more preferably not less than 30%, and even more preferably not less than 40%. The tensile fracture strain of the degradable seal member for downhole tools does not have a particular upper limit, but it is normally not greater than 1000% and often not greater than 900%, because if the tensile fracture strain is too high, the degradable seal member for downhole tools may not easily break into small fragments when it degrades and loses strength. Furthermore, when the thickness of the degradable seal member for downhole tools is small, e.g., not greater than 10 mm, it can sometimes be used even if the tensile fracture strain is less than 20%, e.g., not less than 10%.

When the 23° C. bending elastic modulus and the tensile fracture strain (measured at 23° C.) were ascertained for the aliphatic polyesters that are particularly preferred degradable polymer materials for forming the degradable seal member for downhole tools, they varied depending on the polymerization conditions and the characteristics of the polymer, but were generally as shown in Table 1.

TABLE 1

| | | Tensile fracture strain (%) |
|---|---|---|
| Degradable | Bending elastic | (measurement |
| polymer material | modulus at 23° (GPa) | temperature 23° C.) |
| PGA | 6 to 7 | 3 to 6 |
| SCPLA | 2 to 5 | 20 to 50 |
| PLA | 2 to 5 | 2 to 300 |
| PCL | 1 to 1.5 | 550 to 600 |
| PES | 0.6 to 0.9 | 400 to 600 |
| PBS | 0.2 to 0.7 | 50 to 70 |
| PBSA | 0.3 to 0.4 | 400 to 900 |
| PBAT | 0.05 to 0.1 | 500 to 800 |

From Table 1 it is understood that, when performing a treatment process in a downhole environment in which a degradable seal member for downhole tools is used, for example, in an environment at 177° C., 163° C., 149° C., 121° C., 93° C., 80° C., or 66° C., as well as 25 to 40° C., it is possible to select, as the degradable polymer material that forms the degradable seal member for downhole tools of the present invention, a polymer material that can realize the bending elastic modulus and tensile fracture strain required in the seal member, by taking into consideration the 23° C. bending elastic modulus, the tensile fracture strain (measured at 23° C.), and the melting point (melting temperature).

For example, due to the fact that polybutylene adipate/terephthalate (PBAT) is a polymer material exhibiting a low 23° C. bending elastic modulus of 0.05 to 0.1 GPa, when sealing a fluid between the downhole tool and the casing in a downhole environment that is not at a temperature markedly higher than 23° C., such as 66° C. or thereabout, a degradable seal member for downhole tools formed from PBAT can deform so as to reliably fit to the shape of the downhole tool and the shape of the casing when it incurs large tensile force or compressive force, and there is no risk of fracture. Therefore, the contact area of the degradable seal member for downhole tools and the casing is large, resulting in reliable plugging. Furthermore, for example, PBAT having a 23° C. bending elastic modulus of approximately 0.09 GPa has a 66° C. bending elastic modulus of approximately 0.03 GPa and an 80° C. bending elastic modulus of approximately 0.02 GPa, and therefore, it can deform without fracturing so as to reliably fit to the shape of the downhole tool and the shape of the casing when it incurs large tensile force or compressive force for fluid sealing. Additionally, when sealing a fluid between a downhole tool and a casing, when large deformation is not required in order to reliably fit to the shape of the downhole tool and the shape of the casing, even a degradable seal member for downhole tools formed from a degradable polymer material having a low 23° C. bending elastic modulus may be adequately used, but, as previously described, a 23° C. bending elastic modulus in the range of 0.01 to 8 GPa is preferred from the perspective of reliably exhibiting a sealing function in the downhole tool environment.

Furthermore, in the degradable seal member for downhole tools of the present invention, degradation of the degradable polymer material can be accelerated, and, depending on the case, the degradation behavior of the degradable seal member for downhole tools can be controlled in accordance with the downhole environment such as the temperature, by adjusting the type and content of an acidic substance, preferably an acid-producing substance, used as a degradation accelerator. For example, by including the acidic substance (acid-producing substance) phthalic anhydride in an amount of 5% by mass in PBAT, the compressive strength of the seal member after immersion for 168 hours in 66° C. water decreases to approximately 73% relative to the 23° C. compressive strength, and the compressive strength of the seal member after immersion for 72 hours in 80° C. water decreases to approximately 46% relative to the 23° C. compressive strength. Similarly, by including the acidic substance (acid-producing substance) glycolide in an amount of 5% by mass or 10% by mass in PBAT, the compressive strength of the seal member after immersion for 72 hours in 80° C. water decreases to approximately 60% relative to the 23° C. compressive strength. Therefore, by selecting the degradable polymer material and selecting the degradation accelerator in accordance with the downhole environment, such as the temperature, the sealing performance and degradability of the degradable seal member can be easily designed and adjusted by employing the optimal combination for the degradable seal member for downhole tools.

### [Shape and Size of Degradable Seal Member for Downhole Tools]

The shape and size of the degradable seal member for downhole tools are not particularly limited, and may be adjusted so as to be compatible with the type, shape, and size of the downhole tool that comprises the degradable seal member for downhole tools. For example, it may have a sheet shape (thin film shape, thick plate shape, or the like), a rod shape (round bar shape, polygonal shape, or the like), a rectangular solid shape (including cuboid shapes), a lump shape (regular shape, indeterminate shape, or the like), or the like, or it may be a molded article having a prescribed shape. When the degradable seal member for downhole tools has a sheet shape or is a sealing material or packing material, it does not have to be a molded article having a prescribed shape. When the downhole tool comprising the degradable seal member for downhole tools is a plug for well drilling and completion or the like, it may be a degradable seal member for downhole tools that is an annular molded article, and more specifically, it may be a degradable seal member for downhole tools in which an annular molded article is disposed on an outer circumferential surface orthogonal to the axial direction of a mandrel, or it may be a degradable seal member for downhole tools provided in a plug for well drilling and completion such as a frac plug or bridge plug.

### [Method for Manufacturing Degradable Seal Member for Downhole Tools]

The method for manufacturing the degradable seal member for downhole tools is not particularly limited. For example, molded articles of prescribed shapes are molded or preformed articles are molded by injection molding, extrusion molding (including solidification-and-extrusion molding), centrifugal molding, compression molding, or another known molding method, and then after they are machined such as by cutting or perforating as necessary, they are combined by a known method to produce a degradable seal member for downhole tools.

### II. Downhole Tool

Another aspect of the present invention provides a downhole tool comprising the degradable seal member for downhole tools of the present invention described above. The downhole tool is not particularly limited in its type, shape, and size. For example, the degradable seal member for downhole tools of the present invention may be used as a seal member in a sleeve system (frac sleeve); a seal member such as a ball valve or flapper valve inside a downhole tool; a seal member that can temporarily block a fluid by being disposed in an opening between the downhole tool and the casing; and a seal member in many other seal applications, such as sealing a borehole by means of it covering a downhole tool member made of metal or the like and the metal portion expanding in diameter. From the perspective of being able to more effectively exhibit the characteristics of the degradable seal member for downhole tools of the present invention, a preferred example of the downhole tool is a plug for well drilling and completion, and a more preferred example is a frac plug or bridge plug.

### [Plug for Well Drilling and Completion]

As the plug for well drilling and completion that is the preferred downhole tool comprising the degradable seal member for downhole tools of the present invention (sometimes called “downhole tool of the present invention” hereinafter), one having a known structure, normally comprising a mandrel (which may be solid or may have a hollow part) and various downhole tool members disposed on the outer circumferential surface orthogonal to the axial direction of the mandrel, is suitable. The downhole tool member may be a diameter-expandable annular seal member, which can seal a fluid by expanding in diameter to plug the space between the downhole tool (plug for well drilling and completion) and the casing, and/or a slip, wedge, ring, or other member that expands in diameter to mutually fix the downhole tool (plug for well drilling and completion) and the casing, and may comprise known members.

The downhole tool of the present invention particularly preferably comprises a degradable seal member for downhole tools that is an annular molded article, and most preferably comprises a degradable seal member for downhole tools that is an annular molded article disposed on the outer circumferential surface orthogonal to the axial direction of a mandrel.

Other downhole tool members provided in the downhole tool of the present invention, such as a mandrel, slip, wedge, ring, or the like, may be selected from a range of members having the material, shape, size, mechanical characteristics, and the like conventionally used for that downhole tool member. Therefore, as a mandrel or the like, for example, a member formed from a degradable material may be used, or a member formed from a material containing a reinforcing material may be used, and furthermore, a member formed from a composite material with another member formed from another material may be used. Additionally, the mandrel may have a hollow part, or its diameter may vary along the axial direction, or it may have a fixed part, a stepped part, an indented part, a protruding part, or the like on the outer surface.

### [Downhole Sealing by Downhole Tool]

In order to reliably perform sealing by a downhole tool, the degradable seal member for downhole tools of the present invention expands in diameter in the direction orthogonal to the axial direction of a mandrel provided in the downhole tool, as an annular molded article, preferably an annular molded article disposed on the outer circumferential surface orthogonal to the axial direction, is compressed in the axial direction and shrinks in diameter. It thereby plugs the space between the casing of the borehole and the downhole tool, and seals the fluid.

Furthermore, the operations of retrieving or physically destroying the member for downhole tools can be made completely unnecessary by means of the downhole tool of the present invention comprising both the degradable seal member for downhole tools of the present invention and another member for downhole tools containing a degradable material such as PGA or PLA, preferably PGA. The downhole tool of the present invention, such as a plug for well drilling and completion, comprising the degradable seal member for downhole tools of the present invention is required to have a diversity of performance maintenance time and degradation time, such as diverse strength, according to various environments such as downhole temperatures and according to the processes carried out in those environments. The downhole tool of the present invention can have the characteristic of maintaining a sealing function for a certain time and then being easily disintegrated or removed in various downhole temperature environments, such as, for example, 177° C., 163° C., 149° C., 121° C., 93° C., 80° C., or 66° C., as well as 25 to 40° C. Additionally, depending on sealing performance and degradability characteristics of the degradable polymer material, it is possible to seal a downhole so as to exhibit a specifically effective sealing function followed by degradability in limited downhole environments, as desired, by selecting the combination of PBAT and the degradation accelerator because the mechanical characteristics such as bending elastic modulus and compressive strength of PBAT, for example, are highly temperature-dependent.

### III. Method of Well Drilling and Completion

According to yet another aspect of the present invention, a degradable seal member for downhole tools that is plugging a borehole can be easily degraded to remove it by biodegradation, hydrolysis, or chemical degradation by some other method after the well treatment such as fracturing of the prescribed section is finished or when production of petroleum or natural gas or the like begins after well drilling is finished and the well has been completed, by a method of well drilling and completion in which the fluid between the downhole tool and the casing is sealed using the degradable seal member for downhole tools of the present invention described previously, and specifically using a downhole tool such as a plug for well drilling and completion comprising the degradable seal member for downhole tools, and, by a method of well drilling and completion in which isolation treatment of a borehole is performed using the degradable seal member for downhole tools of the present invention described previously, and specifically using a downhole tool such as a plug for well drilling and completion comprising the degradable seal member for downhole tools, and then the degradable seal member for downhole tools, preferably all or a part of a downhole tool such as a plug for well drilling and completion comprising the degradable seal member for downhole tools, is degraded. As a result, according to the method of well drilling and completion of the present invention, the substantial cost and time conventionally required to remove, retrieve, destroy or fragmentize, by pulverization, perforation, or another method, numerous plugs for well drilling and completion or seal members and the like remaining inside a well after well treatment is finished or after the well is completed become unnecessary, which makes it possible to reduce the expense and shorten the processes of well drilling and completion.

### [Plugging of Borehole]

In the downhole tool of the present invention, due to the application of force in the axial direction of a mandrel to the degradable seal member for downhole tools, for example, a pair of rings, the degradable seal member for downhole tools expands in diameter in the direction orthogonal to the axial direction of the mandrel as the rings shrink in diameter by compression in the axial direction. As a result, the outward part in the direction orthogonal to the axial direction comes in contact with the inner wall of the downhole, and the inward part in the direction orthogonal to the axial direction comes in contact with the outer circumferential surface of the mandrel, thereby plugging the space between the downhole tool and the downhole, and sealing the fluid. Furthermore, when the aforementioned plugging (sealing) is performed in a downhole that is a high-temperature environment where the degradable seal member for downhole tools ends up degrading in a short time, a treatment method can be employed in which the seal performance (strength and the like) can be maintained for a desired time by controlling the ambient temperature of the degradable seal member for downhole tools by injecting fluid from above ground (cooldown injection).

### [Degradation of Downhole Tool]

With the downhole tool such as a plug for well drilling and completion of the present invention, the degradable seal member for downhole tools, and, as desired, degradable mandrels, slips, rings, and the like, can be easily degraded to remove them by biodegradation, hydrolysis, or chemical degradation by some other method after the well treatment such as fracturing of the prescribed section is finished or, typically, when production of petroleum or natural gas or the like begins after well drilling is finished and the well has been completed. The fact that the downhole tool is degraded after isolation treatment of a borehole is performed using the degradable seal member for downhole tools of the present invention provides the following advantages: (i) the seal for preventing movement of fluid inside the well can be released because the seal part is degraded; (ii) unnecessary downhole tools that hinder production are easy to remove; (iii) a downhole tool that requires no fracturing treatment before the start of production is obtained due to the fact that other members provided in the downhole tool are formed from a degradable material such as PGA or PLA, more preferably PGA; (iv) it can be applied to various downhole tools used in a diversity of processes in which any sort of sealing is required, without limitation to downhole tools used in fracturing processes. Furthermore, it is preferred that the degradable seal member for downhole tools remaining after the well treatment has been finished disappears completely by the time production is begun, but even if it does not disappear completely, as long as it is in a state where its strength decreases and it can be disintegrated by stimulation such as water flow in the downhole, the disintegrated degradable seal member for downhole tools can be easily recovered by flowback or the like, and since it does not cause clogging in the downhole or fractures, it does not hinder the production of petroleum, natural gas, or the like. Additionally, normally, the higher the downhole temperature, the shorter the time required for degradation and strength loss of the degradable seal member for downhole tools. Furthermore, depending on the well, the moisture content in the subterranean formation is sometimes low, and in this case, degradation of the downhole tool can be accelerated by allowing the water-based fluid used during fracturing to remain in the well without recovering it after fracturing.

Yet another specific aspect of the present invention provides a method for well drilling and completion, the method comprising sealing a borehole using a downhole tool comprising a degradable seal member for downhole tools formed from a degradable polymer material and having a bending elastic modulus at 23° C. of 0.01 to 8 GPa, and maintaining a stable state in a dry environment and being degradable in fluid of a temperature of not less than 66° C.; and then the degradable seal member for downhole tools being degraded inside the borehole.

Yet another specific aspect of the present invention provides a method for well drilling and completion, the method comprising sealing a borehole using a downhole tool comprising a degradable seal member for downhole tools formed from a degradable polymer material and having a 23° C. bending elastic modulus of 0.01 to 8 GPa, and maintaining a stable state in a dry environment and being degradable in fluid of a temperature of not less than 66° C., the downhole tool further comprising another member for downhole tools containing a degradable material, preferably polyglycolic acid; and then the degradable seal member for downhole tools being degraded inside the borehole.

Yet another specific aspect of the present invention provides a method for well drilling and completion, the method comprising performing well treatment using a downhole tool comprising a degradable seal member for downhole tools formed from a degradable polymer material and having a bending elastic modulus at 23° C. of 0.01 to 8 GPa, and maintaining a stable state in a dry environment and being degradable in fluid of a temperature of not less than 66° C., the degradable seal member for downhole tools being in contact with another member for downhole tools; and then the degradable seal member for downhole tools being degraded inside the borehole.

### INDUSTRIAL APPLICABILITY

The present invention, due to being a degradable seal member for downhole tools characterized by being formed from a degradable polymer material, can provide a member for downhole tools, a downhole tool comprising the member, and a method of well drilling and completion which make it easy to reliably perform various well treatments in well drilling and completion that require sealing operations such as perforation and fracturing by sealing a fluid between the downhole tool and the casing, and, as necessary, can easily remove the seal and secure a flow path under a diversity of well environment conditions based on the fact that excavation conditions have become more harsh and diverse such as increased depth, and contribute to reduced expense or shortening of well drilling and completion, and contribute to improved production efficiency.

1. A degradable seal member for downhole tools comprising a degradable polymer material.

2. The degradable seal member for downhole tools according to claim 1, wherein a bending elastic modulus at 23° C. is from 0.01 to 8 GPa.

3. (canceled)

4. The degradable seal member for downhole tools according to claim 1, wherein the member maintains a stable state in a dry environment and is degradable in fluid of a temperature of not less than 66° C.

5. The degradable seal member for downhole tools according to claim 1, wherein a decrease rate of a 50% strain compressive stress of the degradable polymer material after immersion for 24 hours in 150° C. water relative to a 50% strain compressive stress before immersion is not less than 5%.

6. The degradable seal member for downhole tools according to claim 1, wherein a loss rate of mass of the degradable polymer material after immersion for 72 hours in 150° C. water relative to a mass before immersion is from 5 to 100%.

7. (canceled)

8. The degradable seal member for downhole tools according to claim 1, wherein the degradable polymer material contains not less than two types of degradable polymer material.

9. The degradable seal member for downhole tools according to claim 1, wherein the degradable polymer material contains a polymer material containing at least one ester bond, amide bond, or urethane bond.

10. The degradable seal member for downhole tools according to claim 1, wherein the degradable polymer material contains an aliphatic polyester.

11. The degradable seal member for downhole tools according to claim 10, wherein the aliphatic polyester is a copolymer.

12. The degradable seal member for downhole tools according to claim 10, wherein the aliphatic polyester contains at least one type selected from the group consisting of polylactic acid, stereocomplex-type polylactic acid, polybutylene succinate, polybutylene adipate/terephthalate, and polybutylene succinate/adipate.

13. The degradable seal member for downhole tools according to claim 1, wherein the degradable polymer material contains an acidic substance (which may also be an acid-producing substance).

14. The degradable seal member for downhole tools according to claim 1, wherein the degradable polymer material contains a reinforcing material.

15. The degradable seal member for downhole tools according to claim 1, wherein a tensile fracture strain is not less than 20%.

16. The degradable seal member for downhole tools according to claim 1, wherein the member is an annular molded article disposed on an outer circumferential surface orthogonal to an axial direction of a mandrel provided in a downhole tool.

17. A downhole tool comprising:
the degradable seal member for downhole tools described in claim 1.

18. A method for well drilling and completion, the method comprising:
sealing a fluid between a downhole tool and a casing using the degradable seal member for downhole tools described in claim 1.

19. A method for well drilling and completion, the method comprising:
performing isolation treatment of a borehole using the degradable seal member for downhole tools described in claim 1, and then the downhole tools being degraded.

20. A method for well drilling and completion, the method comprising:
sealing a borehole using a downhole tool comprising a degradable seal member for downhole tools formed from a degradable polymer material and having a bending elastic modulus at 23° C. of 0.01 to 8 GPa, and maintaining a stable state in a dry environment and being degradable in fluid of a temperature of not less than 66° C.; and then the degradable seal member for downhole tools being degraded inside the borehole.

21. A method for well drilling and completion according to claim 20, the method comprising:
sealing a borehole using a downhole tool
further comprising another member for downhole tools containing a degradable material; and then the degradable seal member for downhole tools being degraded inside the borehole.

22. (canceled)

23. A method for well drilling and completion, the method comprising:
performing well treatment using a downhole tool comprising a degradable seal member for downhole tools formed from a degradable polymer material and having a bending elastic modulus at 23° C. of 0.01 to 8 GPa, and maintaining a stable state in a dry environment and being degradable in fluid of a temperature of not less than 66° C., the degradable seal member for downhole tools being in contact with another member for downhole tools; and then the degradable seal member for downhole tools being degraded inside the borehole.
